(19) United States
(12) Patent Application Publication
(10) Pub. No.: US 2016/0039350 A1
(43) Pub. Date: Feb. 11, 2016

(54) VEHICULAR ROOF RACK MOUNTING BRACKET

(71) Applicant: Thule Sweden AB, Hillerstorp (SE)

(72) Inventors: Ash Patel, Newton, CT (US); Joseph R. Flaherty, Prospect, CT (US)

(21) Appl. No.: 14/807,582

(22) Filed: Jul. 23, 2015

Related U.S. Application Data
(60) Provisional application No. 62/033,491, filed on Aug. 5, 2014.

(51) Int. Cl. B60R 9/04

(52) U.S. Cl. CPC B60R 9/04

(57) ABSTRACT

A vehicular roof rack mounting bracket capable of securement onto load carrier bars of different dimensions is presented. The bracket can include an upper jaw, a bolt head receiver space defined within a portion of the upper jaw, and a lower jaw. The bracket can also include a rotary tightener configured to adjustably couple the upper jaw to the lower jaw.

### CROSS-REFERENCE TO RELATED APPLICATIONS

This application claims priority to U.S. Provisional Application No. 62/033,491, filed on Aug. 5, 2014, the disclosure of which is incorporated herein in its entirety by reference thereto.

### FIELD

The present disclosure relates generally to a vehicular roof rack mounting bracket. More specifically, embodiments within this disclosure relate to a mechanism configured to mount a load, such as a sport equipment load carrier, to a cross bar of a vehicle's load rack.

### BACKGROUND

Safely and conveniently transporting sports equipment is a concern for many sports enthusiasts. For example, canoes, kayaks, and bicycles can be carried on the roof of a vehicle via one or more load support bars that are typically mounted horizontally and perpendicularly to the direction of travel. Clamping devices can be used to make the attachment to different shapes and sizes of load support bars.

### BRIEF SUMMARY OF THE INVENTION

Some embodiments are directed towards a bracket for securing a load to a support bar of a vehicle roof rack. The bracket may include a clamp configured to attach to a roof rack, the clamp including an upper jaw and a lower jaw; a T-bolt receiver space defined within a portion of the clamp; and a rotary tightener configured to adjustably couple the upper jaw to the lower jaw.

In some embodiments, the T-bolt receiver space may be defined within the upper jaw and may be centrally located along the length of the upper jaw. In some embodiments, the T-bolt receiver space may be configured to receive the entire head of a T-bolt.

In some embodiments, the T-bolt receiver space may include a through hole in the upper jaw. In some embodiments, the through hole may extend through the upper jaw of the clamp from an upper surface of the upper jaw to a lower surface of the upper jaw.

In some embodiments, the rotary tightener may be pivotally coupled to the lower jaw. In some embodiments, the rotatory tightener may include a female portion pivotally coupled to the lower jaw and a male portion configured to be releasably received in the female portion.

In some embodiments, the upper jaw may include an opening for receiving a portion of the rotary tightener. In some embodiments, the opening includes a central axis extending through the center of the opening and the T-bolt receiver space includes an aperture configured to receive a shaft of a T-bolt, where the central axis of the opening is substantially parallel to a central axis extending through the center of the aperture of the T-bolt receiver space.

In some embodiments, the bracket may also include a T-bolt including a shaft and a head disposed in the T-bolt receiver space, where the shaft of the T-bolt extends from the T-bolt receiver space above an upper surface of the upper jaw.

Some embodiments are directed towards a bracket for securing a load to an elongate support bar of a vehicular roof rack, the bracket including a tightenable clamp having an interior configured to matingly engage about an exterior of an elongate support bar of a vehicular roof rack and a T-bolt head receiver space defined within a portion of the tightenable clamp.

In some embodiments, an interior of the T-bolt head receiver space may be configured to conformance fit about the head of a mating T-bolt.

In some embodiments, the bracket may include an access aperture extending from an upper surface of the tightenable clamp to the T-bolt head receiver space and a portion of the upper surface of the tightenable clamp adjacent to the access aperture may include substantially planar landing surface configured to conformance fit to a lower surface of an installed load carrier.

In some embodiments, at least a portion of the tightenable clamp may be comprised of one or more of the following materials: polypropylene, nylon, glass fibers and UV stabilizer.

In some embodiments, the bracket may include a rotary tightener coupled between two portions of the tightenable clamp and the rotary tightener may include a manual-engagement actuator for transitioning the rotary tightener between a secured configuration and a released configuration, the manual-engagement actuator including a male threaded member and a female threaded member configured for threadable engagement.

In some embodiments, the tightenable clamp may include an upper jaw and a lower jaw coupled together by the rotary tightener. In some embodiments, the upper jaw may include a downwardly concave lower surface and the lower jaw may include an upwardly concave upper surface.

In some embodiments, the rotary tightener may include an elongate rod having a threaded portion. In some embodiments, the rotary tightener may be inserted through at least one aperture in the tightenable clamp.

Some embodiments are directed towards, a bracket for securing a load to an elongate support bar of a vehicular load carrier rack, the bracket including a clamp having an interior configured to matingly engage about an exterior of an elongate support bar of a vehicular load carrier rack, and the clamp including only one location for single point load securement.

### BRIEF DESCRIPTION OF THE DRAWINGS/FIGURES

Implementations of the present application will now be described, by way of example only, with reference to the attached figures, wherein:

FIG. 1 is an exemplary exploded first side elevation view of a vehicular roof rack mounting bracket in accordance with an example embodiment.

FIG. 2 is an exemplary exploded perspective view of the vehicular roof rack mounting bracket of FIG. 1 to be installed on an exemplary low profile load bar.

FIG. 3 is a perspective view of an exemplary embodiment of a sport equipment load carrier comprising the vehicular roof rack mounting bracket of FIG. 1.

FIG. 4 is a front side elevation view of the sport equipment load carrier of FIG. 3.

FIG. 5 is a left side elevation view of the sport equipment load carrier of FIG. 3.

FIG. 6 is a perspective view of another embodiment of a sport equipment load carrier comprising the vehicular roof rack mounting bracket of FIG. 1.

FIG. 7 is a perspective view of the exemplary sport equipment load carrier of FIG. 6 installed on an exemplary low profile load bar.

FIG. 8 is a first perspective view of an upper jaw according to an embodiment.

FIG. 9 is a second perspective view of an upper jaw according to an embodiment.

FIG. 10 is a cross-sectional view of an assembled bracket and load carrier according to an embodiment.

FIG. 11 is a perspective view of an assembled bracket and load carrier according to an embodiment.

### DETAILED DESCRIPTION OF THE INVENTION

It will be appreciated that for simplicity and clarity of illustration, where appropriate, reference numerals have been repeated among the different figures to indicate corresponding or analogous elements. In addition, numerous specific details are set forth in order to provide a thorough understanding of the implementations described herein. However, it will be understood by those of ordinary skill in the art that the implementations described herein can be practiced without these specific details. In other instances, methods, procedures and components have not been described in detail so as not to obscure the related relevant function being described. The description is not to be considered as limiting the scope of the implementations described herein. Descriptions and characteristics of embodiments within this disclosure not mutually exclusive.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other thing that “substantially” modifies, such that the component need not be exact. For example, substantially cylindrical means that the object resembles a cylinder, but can have one or more deviations from a true cylinder. The terms “comprising,” “including” and “having” are used interchangeably in this disclosure. The terms “comprising,” “including” and “having” mean to include, but not necessarily be limited to the things so described.

The present technology can be implemented as a vehicular roof rack mounting bracket. The vehicular roof rack mounting bracket is configured to be coupled to an elongate support bar or load bar of a rack of a vehicle. The load bar can be coupled to the vehicle via feet that are coupled to either a rack rail or to the vehicle directly. The support bar of the vehicular load carrier rack can be coupled to a vehicle's roof, a pick-up truck's bed or at any other location on a carrying vehicle having a rack that includes support bars for receiving loads attached thereto. The support bar can be perpendicular relative to the length of a vehicle. The vehicular roof rack mounting bracket can be implemented as a sporting equipment carrier or can be implemented as a mounting bracket for a sporting equipment load carrier. For example, the vehicular roof rack mounting bracket can include an equipment engaging portion which can be used to support the gunwale of a canoe, kayak or other watercraft in an inverted configuration. In other embodiments, the vehicular roof rack mounting bracket can be included as part of a bike mounting mechanism, a kayak carrier or any other type of equipment load carrier.

The present technology can be implemented as a mounting bracket for releasably attaching a load to a rack. The rack may be coupled to a vehicle. In some embodiments, the vehicle may be motorized (e.g., a car, a truck, a four-wheeler, or a motorized boat). In some embodiments, the vehicle may be not be motorized (e.g., a bike). In some embodiments, the rack may not be coupled to a vehicle. For example, the rack may be a stand-alone rack or a rack coupled to the ground/floor, a wall, a ceiling, a table, etc.

The present technology can include one or more of the features described herein. While some features are described in relation to a particular figure, the features can be implemented with other embodiments.

In one example, the vehicular mounting bracket of the present disclosure is capable of securement to load carrier bars of different dimensions. The vehicular mounting bracket can include an elongate upper jaw or jaw body having a first end opposite a second end. The upper jaw can have a load bar engaging surface. A landing surface can be defined on an upper portion of the upper jaw. The landing surface can be substantially planar and configured to conformance fit to a lower surface of an installed load carrier. In one or more implementations the landing surface can be a cam-receiving, abutment surface. The mounting bracket can also include an elongate lower jaw or jaw body having a first end opposite a second end. The lower jaw can have at least two load bar engaging surfaces on opposite sides of the lower jaw.

The upper jaw can also include a receiver space configured to accept a portion of a bolt, and in particular, the head of a bolt. The bolt can be a T-bolt, a square head bolt, a hex bolt, a hex head flange bolt, a rail bolt, or any other similar type of bolt. In one or more implementations, the bolt is a T-bolt. In such implementations, the T-bolt head is planar and has a substantially uniform thickness. Typically, the bolt head is square or rectangular in shape.

The receiver space can be an elongate channel in which the head of the bolt is variably positionable along a length of the channel. The elongate channel can further include an access aperture extending from an upper surface of the upper jaw to the elongate channel. The access aperture can be an elongate slot defining an open space between the upper surface of the upper jaw and the elongate channel. The width of the elongate channel can be substantially equal to, or greater than, the width of the male portion of the bolt. The length of the elongate slot can be equal to, or lesser than, the length of the elongate channel.

The vehicular roof rack mounting bracket can also include a flip-fastener. A front portion of the flip-fastener can have a cam configured to be coupled to the shaft portion of the upside-down oriented T-bolt and be secured to a portion of a sport equipment load carrier. At least one aperture can extend horizontally through a width of the front portion of flip-fastener and be configured to receive a barrel nut. A back portion of the flip-fastener can include a lock cylinder assembly extending vertically therethrough in a locked configuration. A key can be received in a top portion of the lock cylinder assembly to actuate the lock cylinder assembly. An oblong or elongate lock head can be located on a bottom portion of the lock cylinder assembly. When the key is turned to actuate the lock cylinder assembly, the lock head will rotate to alter the relative orientation of the oblong or elongate lock head. Typically, the elongate lock head passes through a slot in an unlocked configuration in to a lock head receiver space, and is rotated to a locked configuration in which the lock head is trapped beneath the slot in the lock head receiver space.

The upper jaw can contain a slot into the first end for laterally receiving a first take-up mechanism therein.

A second take-up mechanism can be coupled between the second ends of each of the first and second jaw bodies. The second take-up mechanism can be connected by a pivot connection to the second end of the lower jaw. During transition from the first orientation to the second orientation, one of the take-up mechanisms can remain connected to the first and second jaw bodies. Each take-up mechanism can include a manual-engagement actuator and a rotary tightener.

In one or more implementations, the manual-engagement actuator comprises a graspable knob attached to an end of the rotary tightener that is opposite the lower jaw. Rotation of the manual-engagement actuator can reduce an effective length of the take-up mechanism.

A length of the first take-up mechanism and/or second take-up mechanism can be adjusted by changing the length of the rotary actuator. In one or more implementations, the rotary actuators are telescoping members that upon actuation vary the length of the first take-up mechanism and/or second take-up mechanism. The telescoping members of the first take-up mechanism and/or second take-up mechanism can include a male member that is configured to be threaded into a female member. The female member can be pivotably coupled to an end of the lower jaw.

The length of the first take-up mechanism and/or second take-up mechanism can be adjustable such that a first distance between the first load bar engaging surface of the lower jaw and the load bar engaging surface of the upper jaw is adjustable over a first distance range. Similarly, the length of the first take-up mechanism and/or second take-up mechanism can be adjustable such that a second distance between the second load bar engaging surface of the lower jaw and the load bar engaging surface of the upper jaw is adjustable over a second distance range. The first and second distance ranges are different and the first distance range overlaps with the second distance range. A maximum adjustable distance of the first load bar engaging surface of the lower jaw from the load bar engaging surface of the upper jaw can be greater than a maximum adjustable distance of the second load bar engaging surface of the lower jaw from the load bar engaging surface of the upper jaw.

In at least one example, a bracket is disclosed for securing, by a single connection or single point of contact, a load to an elongate support bar of a vehicular load carrier rack. The bracket includes a clamp that has an interior configured to matingly engage about an exterior of an elongate support bar of a vehicular load carrier rack. The clamp only has one attachment location for making a single point load securement. According to the present disclosure, the location for single point load securement can take the form of a T-bolt receiver space located within the clamp. In one example, the T-bolt receiver space is located within an elongate upper jaw of the clamp.

The elongate upper jaw can be fixedly attached to a sport equipment load carrier. The elongate upper jaw can be formed as an integral portion of a load carrier. A lower jaw can include an engagement member configured to be positioned upon at least one of the load bar facing portions of the lower jaw, wherein the engagement member has an exposed surface adapted to engage a load carrier bar in an installed configuration of the vehicular roof rack mounting bracket on a load carrier bar. In another example, a plurality of exchangeable engagement members can be included, and each engagement member can be configured to be positioned upon at least one of the load bar facing portions of the lower jaw, wherein different engagement members are adapted to engage differently dimensioned load carrier bars.

The vehicular roof rack mounting bracket can be releasably attached to a load carrier via a flip-fastener. The flip-fastener includes a tightening cam-end connected to a lever handle. The cam-end is cleft with a barrel nut extending therebetween, and forming an axle about which the flip-fastener rotates or pivots. At a midpoint along the barrel nut, a threaded receiver is located that is oriented perpendicularly to a longitudinal axis of the barrel nut. Therefore, the flip-fastener can be secured to the upper jaw of the bracket by threaded engagement between the barrel nut and the threaded shaft of the T-bolt having its head positioned in the receiving space of the upper jaw.

The flip-fastener can be pivoted to a macro-adjustment position in which the lever handle is oriented vertically and then spun or rotated until the cam-end is near or touching the bracket. The lever handle of the flip-fastener can then be pivoted from its vertical orientation to a horizontal orientation thereby causing a cam lobe of the cam-end to operate on the top of the bracket. This operation expands the distance between the barrel nut and the top of the bracket so that the flip fastener is securely and tightly connected to the bracket. Typically, when the lever handle is in its horizontal orientation, the cam lobe will be in an over-center orientation and thereby biased to the tightly secured configuration.

An upper surface of the bracket can be planar and constitute a landing surface upon which the cam lobe abuts for sliding contact thereupon.

When the flip-fastener is pivoted down to the securing configuration in which the lever handle is horizontal, the oblong or elongate lock head can be insertibly received through an aperture in a portion of a sport equipment load carrier, which is substantially the same shape and dimensions as the lock head, into a lock space that accommodates rotation of the lock head therein. A key can turn the lock cylinder assembly to actuate the lock head by rotating it such that the lock head is no longer in the same orientation as the aperture in the portion of the sport equipment load carrier, and therefore the lock head is trapped below the aperture in the lock space.

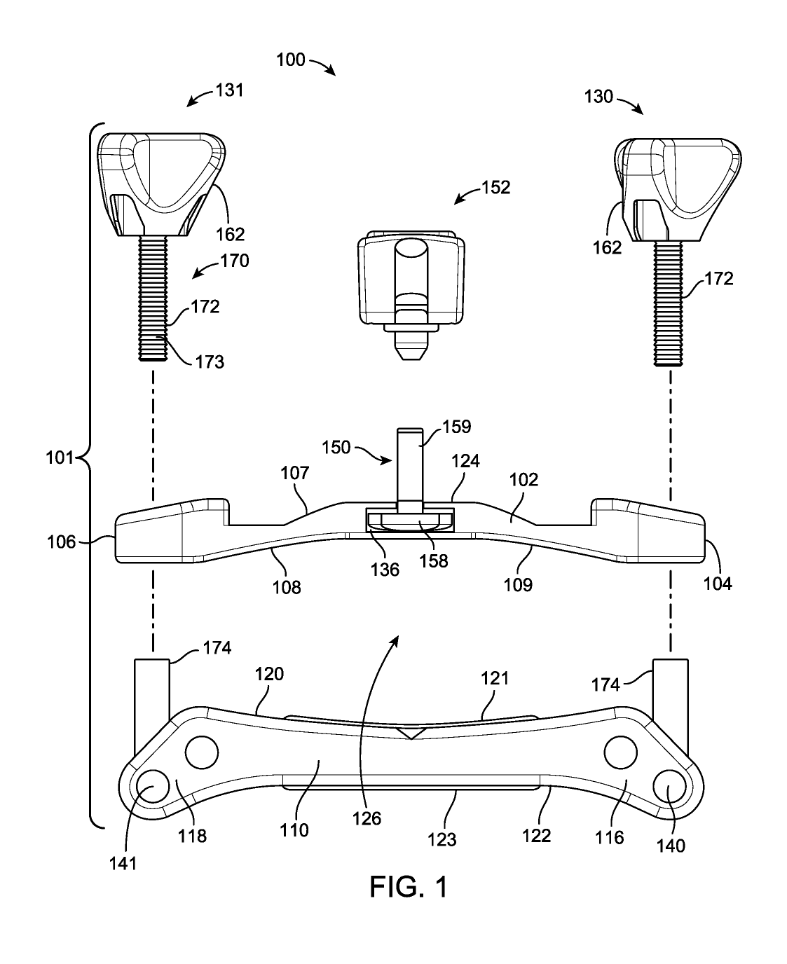

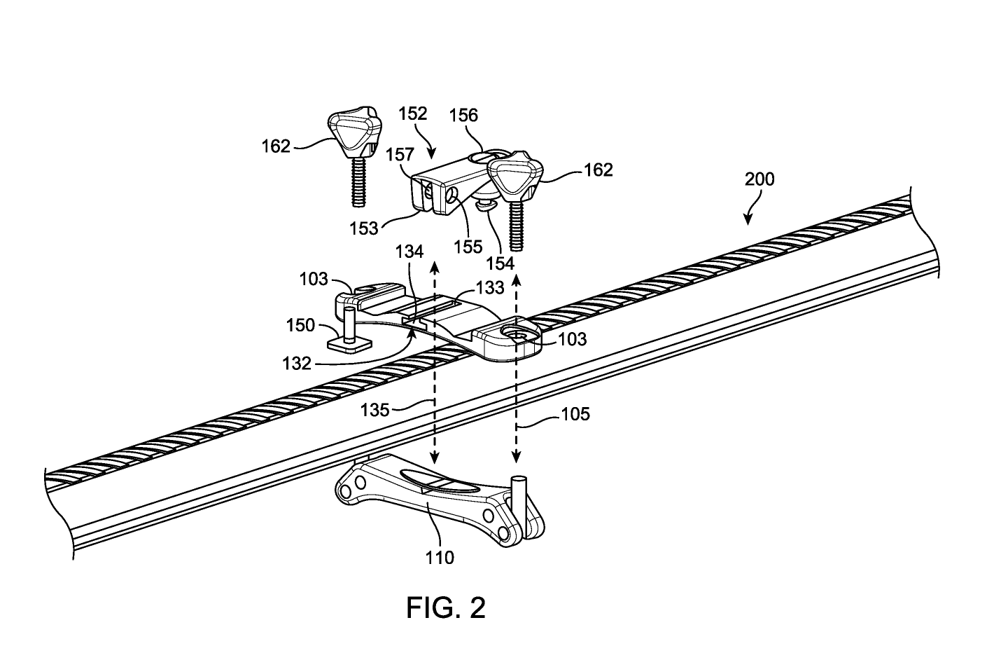

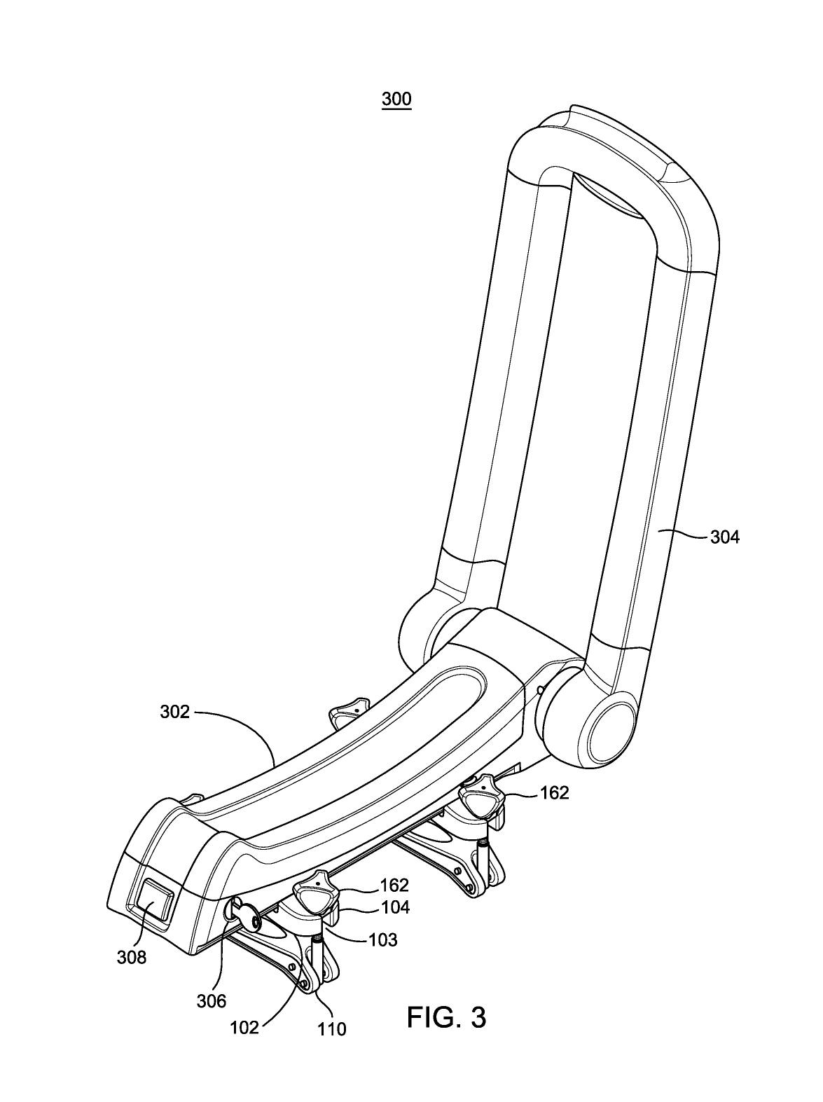

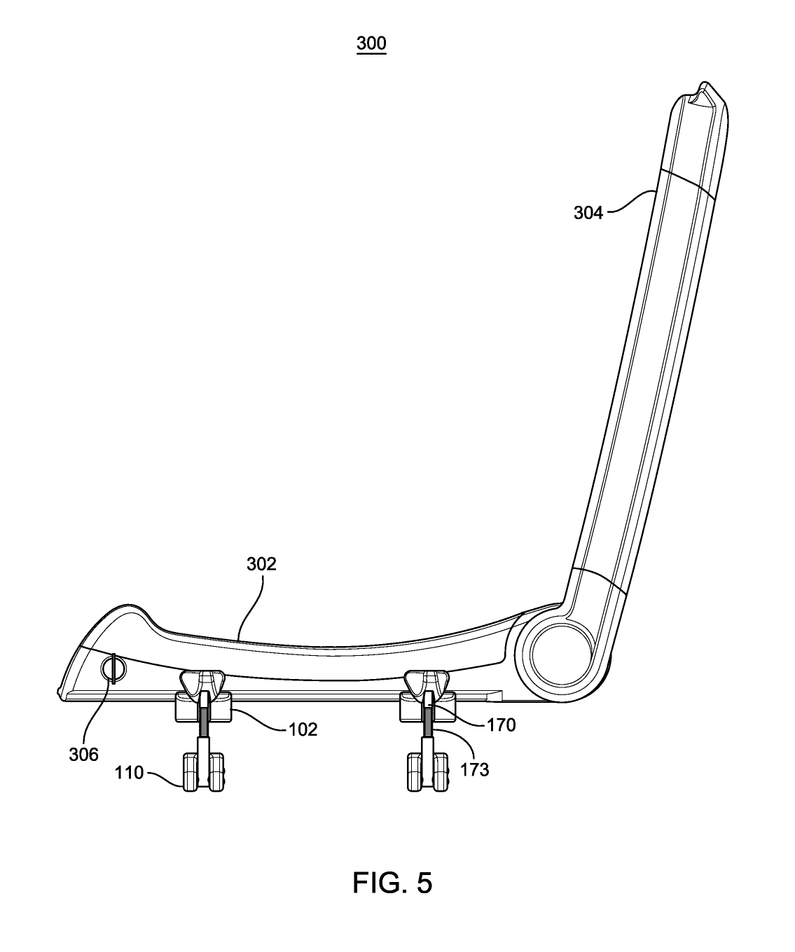

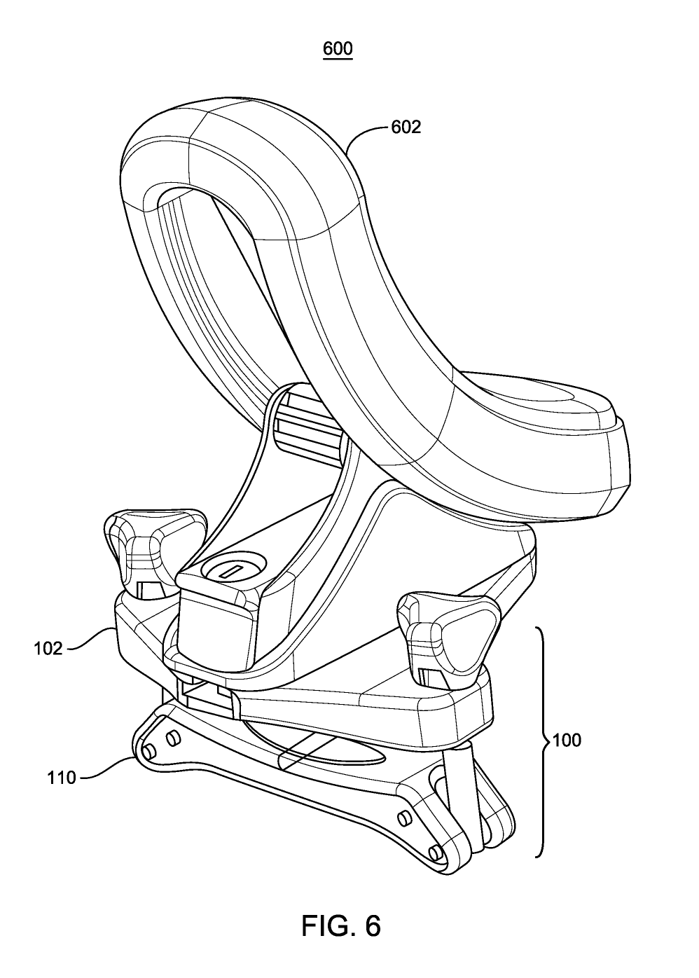

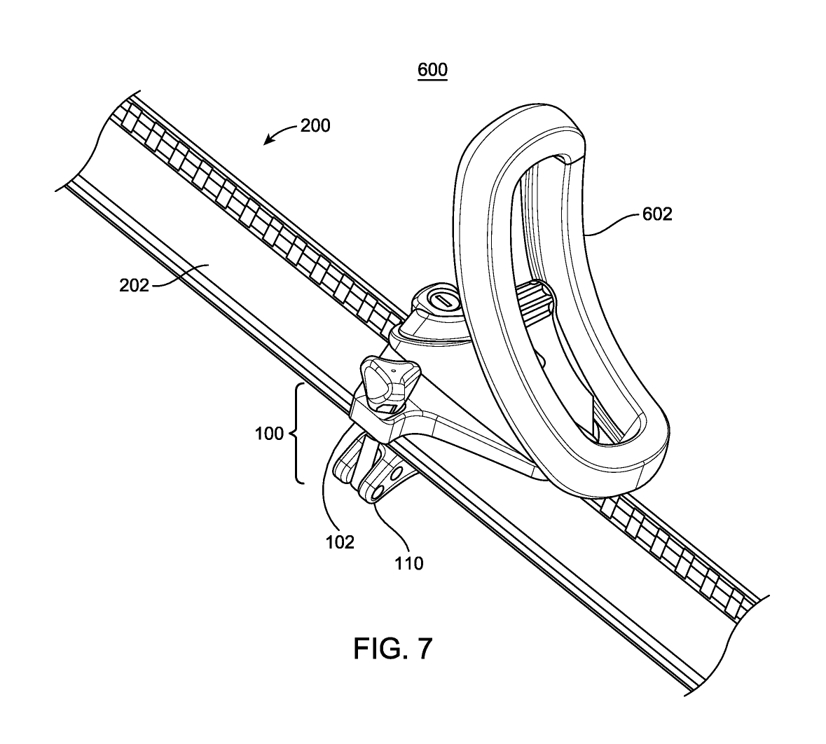

An example of a vehicular rack mounting bracket is now described in relation to FIGS. 1-2. An example of a sport equipment load carrier including the mounting bracket of FIGS. 1-2 is presented in FIGS. 3-5, wherein the vehicular roof rack mounting bracket is included with a sport equipment load carrier comprising a pivotable side-arm. Yet another example of a sport equipment load carrier is presented in FIGS. 6-7, wherein the vehicular rack mounting bracket is included with a sport equipment load carrier comprising a saddle-shaped, load receiving member. These embodiments and examples are not limiting in scope and the vehicular rack mounting bracket can be implemented to secure sporting equipment, cargo boxes, or other items configured to be secured to an elongate support bar of a vehicular mounted load rack.

FIG. 1 is an exemplary side perspective view of a bracket for attachment to an elongate support bar of vehicular load rack which can be a roof top rack. In this example, the bracket is a vehicular roof rack mounting bracket 100 and includes an elongate upper jaw or jaw body 102 (i.e., first jaw portion) having a first end 104 opposite a second end 106. The upper jaw 102 can have a load bar facing portion 108. The load bar facing portion 108 can further include a load bar engaging surface 109 (i.e., lower surface) which can be integrally molded with the load bar facing portion 108. In other embodiments, the load bar engaging surface 109 can be coupled to the load bar facing portion 108. In at least one embodiment, the load bar engaging surface 109 can be removably coupled to the load bar facing portion 108.

The vehicular roof rack mounting bracket 100 can include an elongate lower jaw or jaw body 110 (i.e., second jaw portion) having at least two load bar facing portions 120, 122 on opposite sides of the lower jaw 110. In at least one embodiment, the load bar facing portions 120, 122 can include respective load bar engaging surfaces 121, 123.

Together, upper jaw 102 and lower jaw 110, along with one or more coupling members configured to adjustably couple upper jaw 102 to lower jaw member 110 (e.g., take-up mechanisms 130/131) may form a clamp 101. Clamp 101 may be configured to attach to a rack or a portion of a rack (e.g., the load bar of a roof rack, for example, load bar 200). Moreover, upper jaw member 102 and lower jaw member 110 may define an interior 126 configured to attach to (e.g., matingly engage) an exterior (e.g., exterior 202) of a rack or a portion of a rack (e.g., load bar 200). Interior 126 includes a gap defined, in part, by lower surface 109 of upper jaw 102 and load bar engaging surface 121 of lower jaw 110 (or load bar engaging surface 123 depending on the orientation of lower jaw 110). In some embodiments, the attachment between clamp 101 and the rack or a portion of a rack may be frictional.

In some embodiments, the lower jaw 110 can have lobes 116, 118 that extend obliquely away from a longitudinal axis of the lower jaw 110. The lobes 116, 118 can include pivot connections 140, 141 between respective take-up mechanisms 130, 131 and the lower jaw 110. The take-up mechanisms 130, 131 can be coupled between the ends 104, 106 of the upper jaw 102 and the lobes 116, 118 of the lower jaw 110. Each take-up mechanism 130, 131 can include a rotary tightener. As described below, the rotary tightener can include a male portion 172 and a female portion 174 that are threadably engagable with each other. The length of each take-up mechanism 130, 131 can be adjustable as well. In at least one embodiment, each take-up mechanism 130, 131 can be in the form of a flip-fastener.

The pivot connections 140, 141 can accommodate approximately 180 degree pivotation of the lower jaw 110 about the pivot connections 140, 141 between a first orientation and a second orientation of the lower jaw 110. In the first orientation of the lower jaw 110, a first load bar engaging surface 121 of the at least two load bar engaging surfaces 121, 123 of the lower jaw 110 can face the load bar engaging surface of the upper jaw 102. In the second orientation of the lower jaw 110, a second 122 of the at least two load bar engaging surfaces 121, 123 of the lower jaw 110 can face the load bar engaging surface of the upper jaw 102 and thereby accommodating securement of the vehicular roof rack mounting bracket 100 onto load carrier bars of different dimensions.

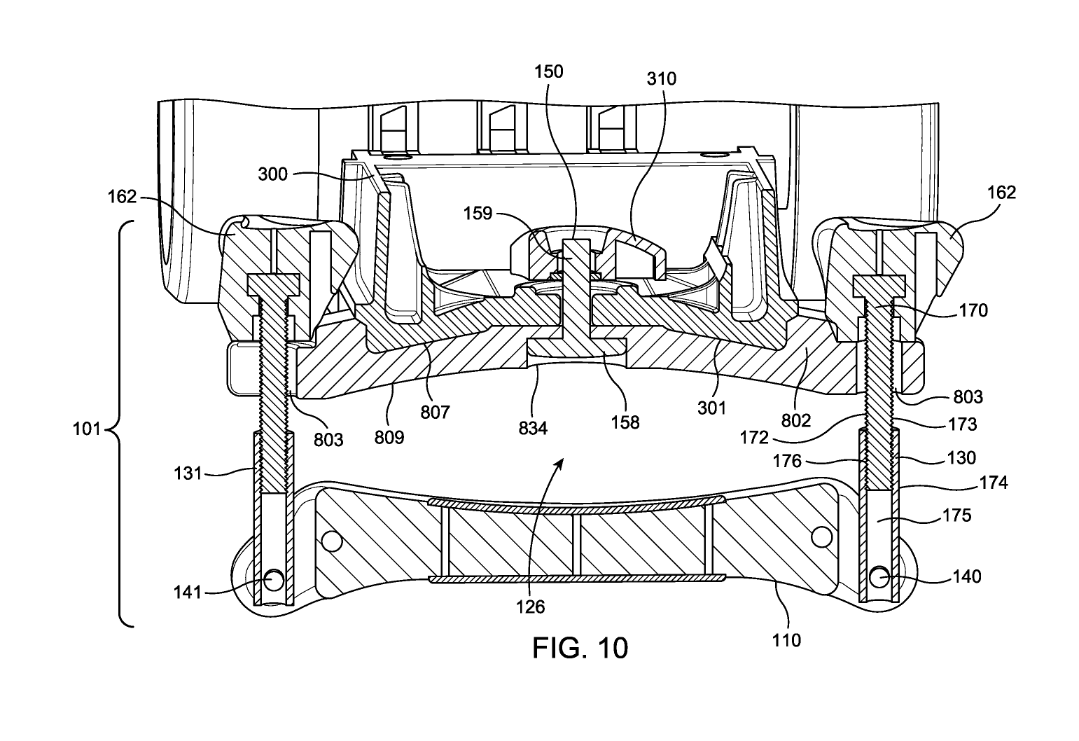

Each take-up mechanism 130, 131 can include a rotary tightener which, in at least one implementation, includes a male portion 172 and a female portion 174. The female portion 174 can include a hollow portion (e.g., hollow shaft 175, see FIG. 10) configured to receive the male portion 172. In some embodiments, male portion 172 can include a rod 170 coupled to a manual-engagement actuator 162. The male portion 172 can be at least partially threaded (see e.g., threaded portion 173). In other embodiments, the male portion 172 can be completely threaded. When the male portion 172 is threaded at least a portion of the female portion 174 can be threaded (e.g., threaded portion 176). In at least one embodiment, the female portion 174 can be completely threaded. In another embodiment, the female portion 174 can be threaded until it reaches a predetermined length. The female portion can have a hole formed cross-wise to the hollow portion of the female portion 174. The hole formed cross-wise can be configured to receive a pin that couples the female portion 174 to the lower jaw 110 (i.e., second jaw portion). The pin allows the female portion 174 to rotate relative to the lower jaw 110. In other embodiments, other coupling connections can be implemented to allow the female portion to rotate relative to the lower jaw 110.

While the illustrated embodiment includes a threaded male portion 172 and a threaded female portion 174, other embodiments can implement other male portions 172 and other female portions 174. For example, the male portion 172 can be coupled to the female portion 174 by a pin connection. In other implementations, the take-up mechanism 130 can include other types of coupling devices such that a portion of the take-up mechanism 130 can be removable coupled to the lower jaw 110.

Moreover, while the female portion 174 has been described as being coupled to lower jaw 110, a male portion 172 may be coupled (e.g., pivotally coupled) to lower jaw 110 in the same or similar fashion as discussed in regards to female portion 174. In such embodiments, female portion 174 may be coupled to a manual-engagement actuator 162.

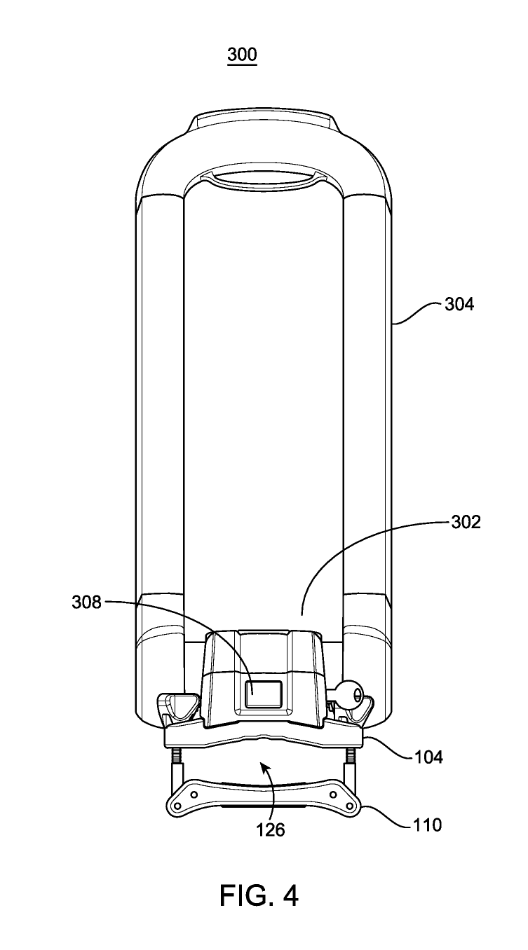

A landing surface 124 can be defined on an upper portion of the upper jaw 102. The landing surface 124 can be substantially planar and configured to conformance fit to a lower surface of an installed load carrier, as shown in FIG. 4. In one or more implementations the landing surface can be a cam-receiving, abutment surface.

FIG. 2 is an exemplary exploded perspective view of the vehicular roof rack mounting bracket 100 to be installed on an exemplary low profile load bar. As shown, the vehicular roof rack mounting bracket 100 can further include a receiver space 134 configured to accept the head of a bolt 150. The bolt 150 can be a T-bolt, a square head bolt, a hex bolt, a hex head flange bolt, a rail bolt, or any other similar type of bolt. In one or more implementations, and as illustrated in FIGS. 1-2, the bolt 150 is a T-bolt. The head of the T-bolt 150 is planar, has a substantially uniform thickness and is square or rectangular in shape.

In some embodiments, the receiver space 134 can be an elongate channel in which the head of the mating bolt 150 is variably positional along a length of the channel. The receiver space 134 can further include an access aperture 133 extending from an upper surface of the upper jaw 102 to the receiver space 134. The access aperture 133 can be an elongate slot defining an open space between the upper surface 107 of the upper jaw 102 and the receiver space 134. The width of the receiver space 134 can be substantially equal to, or greater than, the width of the male portion (e.g., head 158) of the bolt 150. The length of the access aperture 133 can be equal to, or lesser than, the length of the receiver space 134.

An entrance opening 132 to the T-bolt receiver space 134 is provided through the upper jaw 102 to the T-bolt receiver space 134 for permitting insertion of the head 158 of a T-bolt 150 into the T-bolt receiver space 134. Exemplarily, the entrance opening 132 extends from a side surface of the upper jaw 102 to the T-bolt receiver space 134.

In some embodiments, T-bolt receiver space 134 may be centrally located along the length of upper jaw 102. In other words, T-bolt receiver space 134 may be centrally located between first end 104 and second end 106 of upper jaw 102. In some embodiments, an interior 136 of receiver space 134 may be configured to conformance fit about the head 158 of a mating T-bolt 150. In some embodiments, T-bolt receiver space 134 may be configured to receive the entire head 158 of a T-bolt 150 (or other type of bolt).

The vehicular roof rack mounting bracket 100 can also include a flip-fastener 152. A front portion of the flip-fastener 152 can have a cam 153 configured to couple to the bolt 150 and be secured to a portion of a sport equipment load carrier (e.g., load carrier 300). At least one aperture 155 can extend horizontally through a width of the front portion of flip-fastener 152 and be configured to receive a barrel nut 157. A back portion of the flip-fastener 152 can include a lock cylinder assembly 156 extending vertically therethrough. A key (not shown) can be received in a top portion of the lock cylinder assembly 156 to actuate the lock cylinder assembly 156. An oblong or elongate lock head 154 can be located on a bottom portion of the lock cylinder assembly 156. When the key is turned to actuate the lock cylinder assembly, the lock head 154 will rotate to alter the relative orientation of the oblong or elongate lock head 154.

A distance can be formed between the upper jaw 102 and the lower jaw 110. A distance separates a load bar facing portion 108 of the upper jaw 102 from a first load bar facing portion 120 of the lower jaw 110. The load bar facing portion 108 of the upper jaw 102 can have a load bar engaging surface 109 as described above. In at least one embodiment, the load bar facing portion 108 can have a concave shape. In at least one embodiment, the load bar engaging surface 109 can have a concave shape. Other shapes for the load bar engaging surfaces are possible within this disclosure.

The lower jaw 110 can have a first load bar facing portion 120 that has a concave shape. The first load bar facing portion 120 can include a first load bar engaging surface 121 that can have a concave shape. Other shapes for portion 120 and surface 121 are possible.

In some embodiments, load bar facing portion 108 and/or load bar engaging surface 109 may have a downwardly concave surface when assembled with lower jaw 110. In some embodiments, first load bar facing portion 120 and/or first load bar engaging surface 121 may have an upwardly concave surface when assembled with lower jaw 110. In some embodiments, second load bar facing portion 122 and/or second load bar engaging surface 123 may have an upwardly concave surface when assembled with lower jaw 110

The lower jaw 110 can have lobes 116, 118 which extend obliquely away from a longitudinal axis of the lower jaw 110. Each lobe 116, 118 can include a pivot connection 140, 141 between the respective take-up mechanism 130, 131 and the lower jaw 110. The take-up mechanisms 130, 131 can include a manual-engagement actuator 162 which can be in the form of a graspable knob. In at least one embodiment, the manual-engagement actuator 162 can have a smooth outer surface. The manual-engagement actuator 162 can be coupled to an end of the take-up mechanism 130 that can be coupled to upper jaw 102. In the illustrated example, the manual-engagement actuator 162 is coupled to a male portion 172. When the manual-engagement actuator 162 is rotated, the length of the respective take-up mechanism 130, 131 can be lengthened or shortened. As the manual-engagement actuator 162 is rotated, the length can be increased until the take-up mechanisms 130, 131 reach a maximum length.

In some embodiments, as a manual engagement actuator 162 is rotated in a first direction (e.g., counter-clockwise) the length of the respective take-up mechanism 130, 131 can be lengthened (e.g., up to a maximum length). In operation, this may increase the separation between upper jaw 102 and lower jaw 110 (i.e., increase the size of interior 126) to allow bracket 100 to be removed from a rack or a portion of a rack (e.g., load bar 200). Similarly, as the manual engagement actuator 162 is rotated in a second direction (e.g., clockwise) the length of the respective take-up mechanism 130, 131 can be shortened. In operation, this may decrease the separation between upper jaw 102 and lower jaw 110 (i.e., reduce the size of interior 126) for attaching bracket 100 to a rack or a portion of a rack (e.g., load bar 200).

In some embodiments, the lower jaw 110 can have second load bar facing portion 122 that has a concave shape. The second load bar facing portion 122 can include a second load bar engaging surface 123 that can have a concave shape. The load bar facing portion 122 and engaging surface 123 can also have other shapes.

The length of the take-up mechanisms 130, 131 can be adjustable such that a first distance between the first load bar facing portion 120 of the lower jaw 110 and the load bar facing portion 108 of the upper jaw 102 is adjustable over a first distance range, and the length of the take-up mechanism 130 is adjustable such that a second distance between the second load bar facing portion 122 of the lower jaw 110 and the load bar facing portion of the upper jaw 102 is adjustable over a second distance range. The first and second distance ranges are different and the first distance range overlaps with the second distance range. A maximum adjustable distance of the first load bar facing portion 120 of the lower jaw 110 from the load bar facing portion 108 of the upper jaw 102 is greater than a maximum adjustable distance of the second load bar facing portion 122 of the lower jaw 110 from the load bar facing portion 108 of the upper jaw 102.

The upper jaw 102, the lower jaw 110, and the take-up mechanisms 130, 131 combine to form a tightenable clamp 101. The tightenable clamp 101 can be comprised of one or more of the following materials chosen from the group including polypropylene, nylon, glass fibers and UV stabilizer.

In some embodiments, the elongate upper jaw 102 can be a separate piece fixedly attached to a load carrier (e.g., load carrier 300). In some embodiments, the elongate upper jaw 102 may be formed as an integral portion of a load carrier.

In some embodiments, upper jaw 102 may be fixedly attached to a load carrier via T-bolt 150 or other suitable bolt, such as a square head bolt, a hex bolt, a hex head flange bolt, or a rail bolt. In some embodiments, as shown for example in FIG. 10, a fastener 310 (e.g., threaded fastener) may be configured to releasably couple with a shaft 159 of T-bolt 150 (or other type of bolt) extending above upper surface 107 of upper jaw 102. In such embodiments, fastener 310 may be tightened to secure upper jaw 102, and therefore bracket 100, to a load carrier. The operation of fastener 310 is described in more detail below with regards to FIG. 10. In some embodiments, a T-bolt 150 may be the only location for single point load securement (e.g., securement of a load carrier 300).

In some embodiments, the vehicular roof rack mounting bracket 100 may be alternatively or additionally fixedly attached to a load carrier via one or more flip-fasteners 152. The flip-fastener 152 can be secured to the upper jaw 102 by threadable engagement to a barrel nut 157 of the flip-fastener 152 with a bolt located in the receiver space 134 of the upper jaw 102. The flip-fastener 152 can be axially positioned relative to the bolt 150 and rotated until sufficiently tight. The flip-fastener 152 can then be pivoted via a lever handle so that the cam 153 slides on a planar surface of the upper jaw 102 constituting a cam lobe landing surface 124. Upon pivotation of the lever to the horizontal orientation, the oblong or elongate lock head 154 can be received by an aperture (not shown) in a portion of a load carrier having substantially the same shape and dimensions as the lock head 154. A key (not shown) can turn the lock cylinder assembly 156 to actuate the lock head 154 to rotate it such that the lock head 154 is no longer in the same orientation as the aperture in the bottom portion of the load carrier.

The operation of flip-fastener 152 may serve one or more of the following purposes: 1) to secure upper jaw 102 to a load carrier and 2) to lock upper jaw 102 to a load carrier. The flip-fastener 152 may secure upper jaw 102 to a load carrier by threadably receiving a shaft of a bolt (e.g., shaft 159 of T-bolt 150) received within a bolt-receiver space (e.g., T-bolt receiver space 134 or T-bolt receiver space 834) of upper jaw 102. In some embodiments, a barrel nut 157 on flip-fastener 152 may threadably receive shaft 159 so that flip-fastener 152 can be rotated and tightened onto T-bolt 150. Once tightened, flip-fastener 152 may be pivoted to the horizontal position (horizontal position of flip-fastener 152 is shown in FIG. 2). In some embodiments, pivoting of flip-fastener 152 to the horizontal position may to provide for additional tightening of flip-fastener 152 and T-bolt 150. Additional tightening may be produced by the shape of cam 153. In such embodiments, cam 153 may be shaped such that the distance between barrel nut 157 and landing surface 124 is greater when flip-fastener 152 is in the horizontal position, compared to the vertical position. This will result in an additional force pulling the head of a bolt (e.g., head 158 of T-bolt 150) towards cam 153 of flip-fastener 152 (e.g., along central axis 135) when flip-fastener 152 is in the horizontal position, compared to the vertical position.

Lock head 154 may lock upper jaw 102 to the load carrier when flip-fastener 152 is the horizontal position. In the horizontal position, lock head 154 may be received within an aperture formed in load carrier. And lock cylinder assembly 156 may be actuated to place lock head 154 in a locked position within the aperture. Once in the locked position, lock head 154 prevents flip-fastener 152 from be pivoted to the vertical position and prevents flip-fastener 152 from being decoupled (e.g., unscrewed) from a bolt. This locking feature of flip-fastener 152 may prevent unauthorized disassembly of a load carrier from bracket 100.

FIG. 3 is a perspective view of an exemplary embodiment of a sport equipment load carrier 300 comprising the vehicular roof rack mounting bracket 100 of FIG. 1. As illustrated, the sports equipment load carrier 300 can include a base portion 302 and an arm or brace portion 304. The base portion 302 can be substantially parallel with the load bar facing portion 108. The base portion 302 can be substantially flat. In other embodiments, the base portion 302 can have a slope, angle or curvature. The base portion 302 can include a pad that is configured to receive a portion of a sports equipment load. The arm portion 304 can be formed such that it forms a substantially right angle, or slightly more than a right angle, with the base portion 302. The arm portion 304 provides for a barrier against lateral movement of the sports equipment on the base portion 302. The arm portion 304 is configured to pivotably rotate between a closed configuration, where the arm portion 304 is substantially horizontal to the base portion 302, and an open configuration, where arm portion 304 forms a substantially right angle, or slightly more than a right angle, with the base portion 302.

In some embodiments, the sport equipment load carrier 300 can further comprise a lock cylinder assembly 306 and a release tab 308. In one or more implementations, the lock cylinder assembly 306 is positioned adjacent to the release tab 308, and above, a vehicular rook rack mounting bracket 100. As shown in FIG. 3, the lock cylinder assembly 306 and release tab 308 can be located at an end of the sport equipment load carrier 300 opposite the arm portion 304. In one or more implementations, the lock cylinder assembly 306 and the release tab 308 can be located at the same end of the sport equipment load carrier as the arm portion 304.

In a locked configuration, the base portion 302 covers and secures the flip-fastener 152 (or other fastener(s), such as fastener 310). In an unlocked configuration the release tab 308 can be pressed to allow for removal of a top portion of the base portion 302 to allow access to the flip-fastener 152 (or other fastener(s), such as fastener 310). This locking feature of load carrier 300 may prevent unauthorized disassembly of load carrier 300 from bracket 100 since it prevents an individual from accessing the fastener coupling bracket 100 to load carrier 300 (e.g., flip-fastener 152 or fastener 310).

As shown in FIGS. 3-5, the vehicular roof rack mounting bracket 100 can include a an aperture/opening (e.g., slot 103) formed in the first end 104 of the upper jaw 102 at a first end 104. The first take-up mechanism 130 rotates about a pivot connection 140 and through the slot 103. The second take-up mechanism 131 can be coupled to the lower jaw 110 by a pivot connection 141. After the first take-up mechanism 130 has passed through the slot 103, the lower jaw 110 can rotate about the pivot connection 141.

In some embodiments, upper jaw 102 can include an aperture/opening 103 (e.g., a through hole) formed in the second end 106 for receiving a portion of take-up mechanism 131. As shown for example, in FIG. 2, opening 103 may include a central axis 105 extending through the center of opening 103. In some embodiments, central axis 105 of opening 103 may be substantially parallel to a central axis 135 extending through the center of access aperture 133 of T-bolt receiver space 134 (see e.g., FIG. 2). In some embodiments, opening on first end 104 (e.g., slot 103) may alternatively or additionally include a central axis ending through the center thereof that is parallel to central axis 135 of access aperture 133.

FIG. 6 is a perspective view of another embodiment of a sport equipment load carrier 600 comprising the vehicular roof rack mounting bracket 100 of FIG. 1. In one or more implementations, the flip-fastener 152 can secure a saddle-shaped sports equipment engagement portion 602 to the upper jaw 102 by threadable engagement of the barrel nut (not shown in FIG. 6) and the bolt (not shown in FIG. 6) located in the receiver space 134 via the access aperture 133. In one or more implementations, the lock head 154 can be received in a portion of the sport equipment load carrier 600.

In some embodiments, sport equipment load carrier 600 may alternatively or additionally be secured to upper jaw 102 via a different type of fastener, such as fastener 310 discussed below in regards to FIG. 10. In some embodiments, load carrier 600 may include a lock cylinder assembly and release tab for locking and unlocking a base portion that covers and secures flip-fastener 152 (or other fastener(s), such as fastener 310) in the same or similar manner as discussed above in regards to load carrier 300.

FIG. 7 is a perspective view of the sport equipment load carrier 600 in an installed configuration on an exemplary low profile load bar 200 (e.g., elongate support bar) according to an example embodiment. The exemplary low profile load bar 200 can have an airfoil like shape to reduce drag. As illustrated, the vehicular roof rack mounting bracket 100 is coupled to the load bar 200 by clamping the load bar 200 between the upper jaw 102 and the lower jaw 110.

The vehicular roof rack mounting bracket 100 can be implemented with sport equipment load carriers such as carriers configured to transport bicycles, skis, cargo containers, kayaks, canoes, and other objects to be placed on a roof of a vehicle.

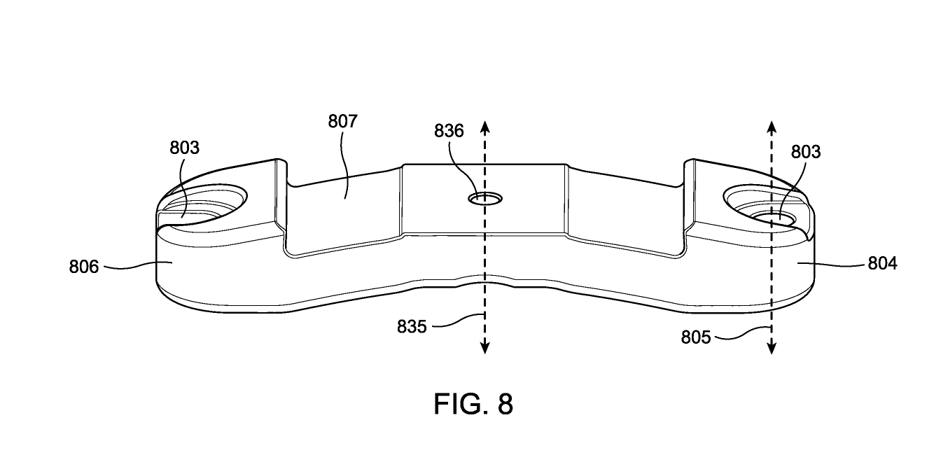

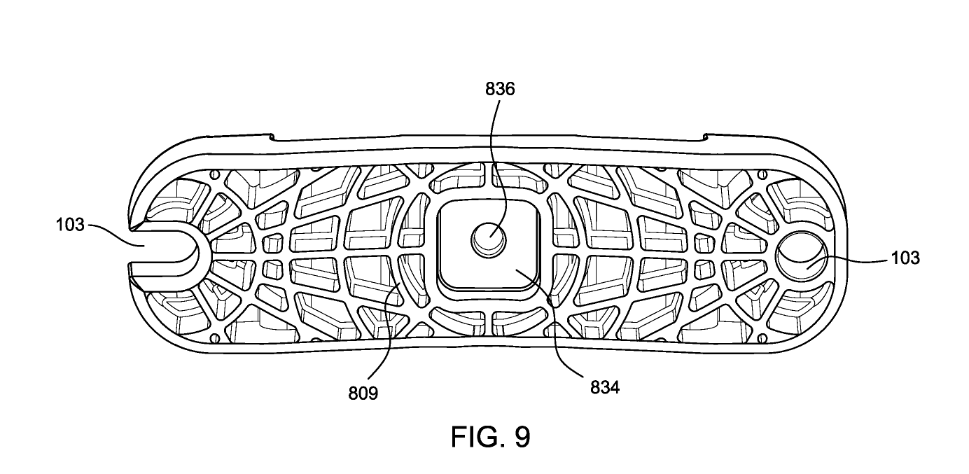

FIGS. 8 and 9 show an upper jaw 802 according to an embodiment. Upper jaw 802 may be used with lower jaw 110 and take-up mechanism(s) 130, 131 to form a clamp 101 in the same or similar fashion as discussed above in regards to upper jaw 102. In other words, upper jaw 802 may take the place of upper jaw 102 in clamp 101 and perform the same or similar functions as upper jaw 102.

Upper jaw 802 includes a first end 804, a second end 806, an upper surface 807, and a lower surface 809. First end 804, second end 806, upper surface 807, and lower surface 809 may be the same as or similar to first end 104, second end 106, upper surface 107, and lower surface 109, respectively.

Upper jaw 802 may include a T-bolt receiver space 834 defined within a portion of upper jaw 802. In some embodiments, T-bolt receiver space 834 may be centrally located along the length of upper jaw 802 (i.e., centrally located between first end 804 and second end 806). In some embodiments, T-bolt receiver space 834 may be configured to receive a portion of a head of a T-bolt (e.g., head 158 of T-bolt 150). In some embodiments, T-bolt receiver space 834 may be configured to receive the entire head of a T-bolt. In some embodiments, T-bolt receiver space 834 may be sized and shaped (i.e., dimensioned) to conformance fit with T-bolt 150. In some embodiments, T-bolt receiver space 834 may be configured to receive one or more of a square head bolt, a hex bolt, a hex head flange bolt, and a rail bolt. In such embodiments, T-bolt receiver space 834 may be configured to receive the entire head of and/or may be sized and shaped (i.e., dimensioned) to conformance fit with any of these types of bolt heads.

In some embodiments, T-bolt receiver space 834 may include a through hole 836. Through hole 836 may extend through upper jaw 802 from upper surface 807 of upper jaw 802 to lower surface 809 of upper jaw 802. In some embodiments, the central axis 805 of an opening 803 (e.g., through hole or slot formed in first end 804 and/or second end 806) may be substantially parallel to a central axis 835 extending through the center of through hole 836 of T-bolt receiver space 834 (see e.g., FIG. 8).

FIG. 10 shows a cross-sectional view of an assembled bracket 100 according to an embodiment. When assembled, a portion of take-up mechanisms 130, 131 may be received within openings 803 in upper jaw 802. In some embodiments, the pivotal coupling between take-up mechanisms 130, 131 and lower jaw 110 at pivot connections 140, 141 facilitates the alignment and coupling of upper jaw 802 and lower jaw 110. As shown in FIG. 10, take-up mechanisms 130, 131 may include a female portion 174 with a hollow shaft 175 pivotally coupled to lower jaw 110 at pivot connections 140, 141. In some embodiments, hollow shaft 175 may include a threaded portion 176 for releasably receiving a threaded portion 173 on a male portion 172 of take-up mechanisms 130, 131.

In some embodiments, male portions 172 may include a rod 170 having a threaded portion 173 for being releasably received by threaded portion 176 of female portions 174. In some embodiments, rod 170 may include a first end coupled to a manual-engagement actuator 162 and a second end including threaded portion 173.

FIG. 10 also shows a releasable connection between clamp 101 and load carrier 300 via a T-bolt 150. As shown in FIG. 10, T-bolt 150 may be received within T-bolt receiver space 834 of upper jaw 802 such that a portion of a shaft 159 of T-bolt 150 extends above upper surface 807 of upper jaw 802. In some embodiments, shaft 159 may include threading for releasably coupling to a fastener 310. In some embodiments, fastener 310 may include a nut (e.g., hex nut or wing nut) with threading configured to releasably engage the threading on shaft 159 of T-bolt 150. In such embodiments, fastener 310 may be tightened and untightened by rotating fastener 310. In some embodiments, fastener 310 may include a gripping portion configured to facilitate rotation (and thus tightening/untightening) of fastener 310 by an operator's hand.

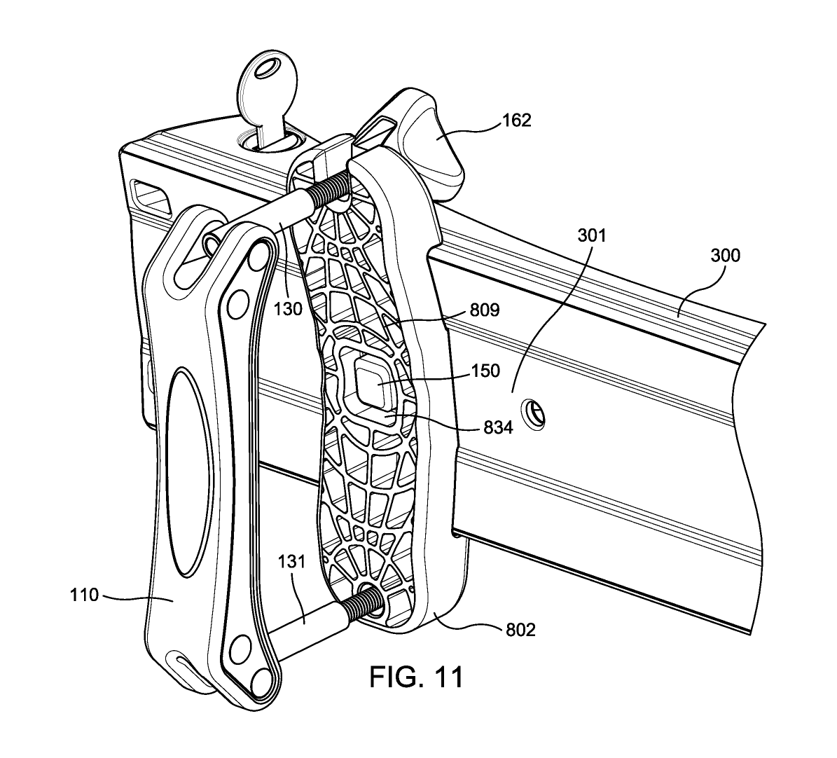

While fastener 310, and the connection between fastener 310 and T-bolt 150, has been described as being threaded, other types of fasteners may be used, such as but not limited to, luer-lock fasteners, snap-fit fasteners, and pin/slot fasteners. In operation, the engagement between fastener 310 and T-bolt 150 releasably secures clamp 101 to load carrier 300 (e.g., by holding upper surface 807 of upper jaw 802 against a lower surface 301 of load carrier 300). FIG. 11 shows a perspective view of clamp 101 secured to load carrier 300. As shown in FIGS. 10 and 11, head 158 of T-bolt 150 may be entirely received within T-bolt receiver space 834 when T-bolt 150 and clamp 101 are assembled. This may facilitate proper attachment of lower surface 809 of upper jaw 802 to a rack or a portion of a rack (e.g., load bar 200) since T-bolt 150 will not interfere with the coupling of lower surface 809 and exterior 202 of load bar 200 if it is entirely received within T-bolt receiver space 834.

Example implementations have been described hereinabove regarding various example embodiments. The example embodiments are intended to constitute non-limiting examples. The subject matter that is intended to be within this disclosure is set forth in the following claims.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventor(s), and thus, are not intended to limit the present invention(s) and the appended claims in any way.

The present invention(s) has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention(s) that others can, by applying knowledge within the skill of the art, readily modify and/or adapt for various applications such specific embodiments, without undue experimentation, without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention(s) should not be limited by any of the above-described exemplary embodiments, but should be defined only in accordance with the following claims and their equivalents.

What is claimed is:

1. A bracket for securing a load to a support bar of a vehicle roof rack, the bracket comprising:
a clamp configured to attach to a roof rack, the clamp comprising an upper jaw and a lower jaw;
a T-bolt receiver space defined within a portion of the clamp; and
a rotary tightener configured to adjustably couple the upper jaw to the lower jaw.

2. The bracket of claim 1, wherein the T-bolt receiver space is defined within the upper jaw and is centrally located along the length of the upper jaw.

3. The bracket of claim 1, wherein the T-bolt receiver space is configured to receive the entire head of a T-bolt.

4. The bracket of claim 1, wherein the T-bolt receiver space comprises a through hole in the upper jaw.

5. The bracket of claim 4, wherein the through hole extends through the upper jaw of the clamp from an upper surface of the upper jaw to a lower surface of the upper jaw.

6. The bracket of claim 1, wherein the rotary tightener is pivotally coupled to the lower jaw.

7. The bracket of claim 1, wherein the rotatory tightener comprises a female portion pivotally coupled to the lower jaw and a male portion configured to be releasably received in the female portion.

8. The bracket of claim 1, wherein the upper jaw comprises an opening for receiving a portion of the rotary tightener.

9. The bracket of claim 8, wherein the opening comprises a central axis extending through the center of the opening, wherein the T-bolt receiver space comprises an aperture configured to receive a shaft of a T-bolt, and wherein the central axis of the opening is substantially parallel to a central axis extending through the center of the aperture of the T-bolt receiver space.

10. The bracket of claim 1, further comprising a T-bolt comprising a shaft and a head disposed in the T-bolt receiver space, wherein the shaft of the T-bolt extends from the T-bolt receiver space above an upper surface of the upper jaw.

11. A bracket for securing a load to an elongate support bar of a vehicular roof rack, the bracket comprising:
a tightenable clamp having an interior configured to matingly engage about an exterior of an elongate support bar of a vehicular roof rack; and
a T-bolt head receiver space defined within a portion of the tightenable clamp.

12. The bracket of claim 11, wherein an interior of the T-bolt head receiver space is configured to conformance fit about the head of a mating T-bolt.

13. The bracket of claim 11, further comprising:
an access aperture extending from an upper surface of the tightenable clamp to the T-bolt head receiver space; and
a portion of the upper surface of the tightenable clamp adjacent to the access aperture comprises a substantially planar landing surface configured to conformance fit to a lower surface of an installed load carrier.

14. The bracket of claim 11, wherein at least a portion of the tightenable clamp is comprised of one or more of the following materials: polypropylene, nylon, glass fibers and UV stabilizer.

15. The bracket of claim 11, further comprising:
a rotary tightener coupled between two portions of the tightenable clamp;
wherein the rotary tightener comprises a manual-engagement actuator for transitioning the rotary tightener between a secured configuration and a released configuration, the manual-engagement actuator comprising a male threaded member and a female threaded member configured for threadable engagement.

16. The bracket of claim 11, wherein the tightenable clamp comprises an upper jaw and a lower jaw coupled together by the rotary tightener.

17. The bracket of claim 16, wherein the upper jaw comprises a downwardly concave lower surface and the lower jaw comprises an upwardly concave upper surface.

18. The bracket of claim 15, wherein the rotary tightener comprises an elongate rod having a threaded portion.

19. The bracket of claim 18, wherein the rotary tightener is inserted through at least one aperture in the tightenable clamp.

20. A bracket for securing a load to an elongate support bar of a vehicular load carrier rack, the bracket comprising:
a clamp having an interior configured to matingly engage about an exterior of an elongate support bar of a vehicular load carrier rack; and
the clamp comprising only one location for single point load securement.
